(19) United States
(12) Patent Application Publication
(10) Pub. No.: US 2013/0143110 A1
(43) Pub. Date: Jun. 6, 2013

(54) SYSTEM AND METHOD FOR ENCLOSING AN ENERGY STORAGE CELL

(71) Applicants: Roger Neil BULL, Etwall (GB); Neil Anthony Johnson, Schnectady, NY (US); Owen Scott Quirion, Clifton Park, NY (US); James Lowe Sudworth, Burton Upon Trent (GB); Paul Sudworth, Ashby de la Zouch Leics (GB); Alec Roger Tilley, Ashbourne (GB); Edward James Balaschak, Avon, OH (US)

(72) Inventors: Roger Neil BULL, Etwall (GB); Neil Anthony Johnson, Schnectady, NY (US); Owen Scott Quirion, Clifton Park, NY (US); James Lowe Sudworth, Burton Upon Trent (GB); Paul Sudworth, Ashby de la Zouch Leics (GB); Alec Roger Tilley, Ashbourne (GB); Edward James Balaschak, Avon, OH (US)

(21) Appl. No.: 13/308,652

(22) Filed: Dec. 1, 2011

(51) Int. Cl. H01M 2/30; H01M 6/00; H01M 2/06

(52) U.S. Cl. 429/179; 429/122; 29/623.1

(57) ABSTRACT

A terminal apparatus for an energy storage cell is presently disclosed. The terminal apparatus includes a terminal body with a peripheral edge extending substantially around a perimeter of the terminal body such that the terminal body is configured to be secured to a cell housing to retain an electrochemical cell in the cell housing, a terminal connector extending from the peripheral edge forming a first terminal for an energy storage cell, a sealable vacuum port extending through the terminal body, and an aperture in the terminal body configured to receive a second terminal of the energy storage cell. A method of manufacturing an energy storage cell is also disclosed.

### BACKGROUND

1. Technical Field

The subject matter disclosed herein relates to an enclosure for an energy storage cell.

2. Discussion of Art

Energy storage cells may have challenges with leakage and manufacturability. Multiple welded seams may increase the number of discontinuities in the packaging, which may result in inefficient thermal management or increased electrical resistance limiting the efficiency of the cell. Multiple welded seams may also adversely affect the manufacturability of energy storage cells having an electrochemical cell under vacuum within the cell housing.

It may be desirable to have an enclosure for an energy storage cell that differs from those that are currently available.

### BRIEF DESCRIPTION

Presently disclosed is a terminal apparatus. In an embodiment, the terminal apparatus includes a terminal body having a peripheral edge extending substantially around a perimeter of the terminal body such that the terminal body is configured to be secured to a cell housing to retain an electrochemical cell in the cell housing; a terminal connector extending from the peripheral edge forming a first terminal for an energy storage cell; a sealable vacuum port extending through the terminal body; and an aperture in the terminal body configured to receive a second terminal of the energy storage cell.

Also disclosed is a method of manufacturing an energy storage cell. In embodiments, the method includes the steps of securing a terminal body to a cell housing containing an electrochemical cell; evacuating the energy storage cell through a vacuum port of the terminal body; and sealing the vacuum port to maintain a partial pressure within the energy storage cell.

An energy storage cell is also disclosed. In embodiments, the energy storage cell includes an rechargeable electrochemical cell and a cell housing, wherein the electrochemical cell is disposed within the cell housing. The energy storage cell also includes a terminal apparatus secured to the cell housing to retain the electrochemical cell, wherein the terminal apparatus includes a monolithic terminal body with a peripheral edge extending substantially around a perimeter of the terminal body wherein the peripheral edge is secured to the cell housing to provide a seal; a terminal connector extending from the peripheral edge forming a first terminal for the energy storage cell; a sealable vacuum port extending through the terminal body; and an aperture in the terminal body configured to receive a second terminal of the energy storage cell; and wherein the electrochemical cell is secured to the terminal body to provide a seal such that the energy storage cell is configured to be evacuated through the sealable vacuum port and configured to maintain a partial pressure when the sealable vacuum port is sealed.

### BRIEF DESCRIPTION OF THE DRAWINGS

Reference is made to the accompanying drawings in which particular embodiments and further benefits of the invention are illustrated as described in more detail in the description below, in which:

FIG. 1 is a perspective view of an embodiment of a terminal for an energy storage cell;

FIG. 2 is a top view of the embodiment of a terminal of FIG. 1;

FIG. 3 is a cross-section of the terminal along line 3-3;

FIG. 4 is a cross-section of the terminal along line 4-4;

FIG. 5 is a perspective view of another embodiment of a terminal for an energy storage cell;

FIG. 6 is a perspective view of another embodiment of a terminal for an energy storage cell;

FIG. 7 is a cross-section of the embodiment of a terminal of FIG. 6 along section line 7-7; and

FIG. 8 is a perspective view of an energy storage cell.

### DETAILED DESCRIPTION

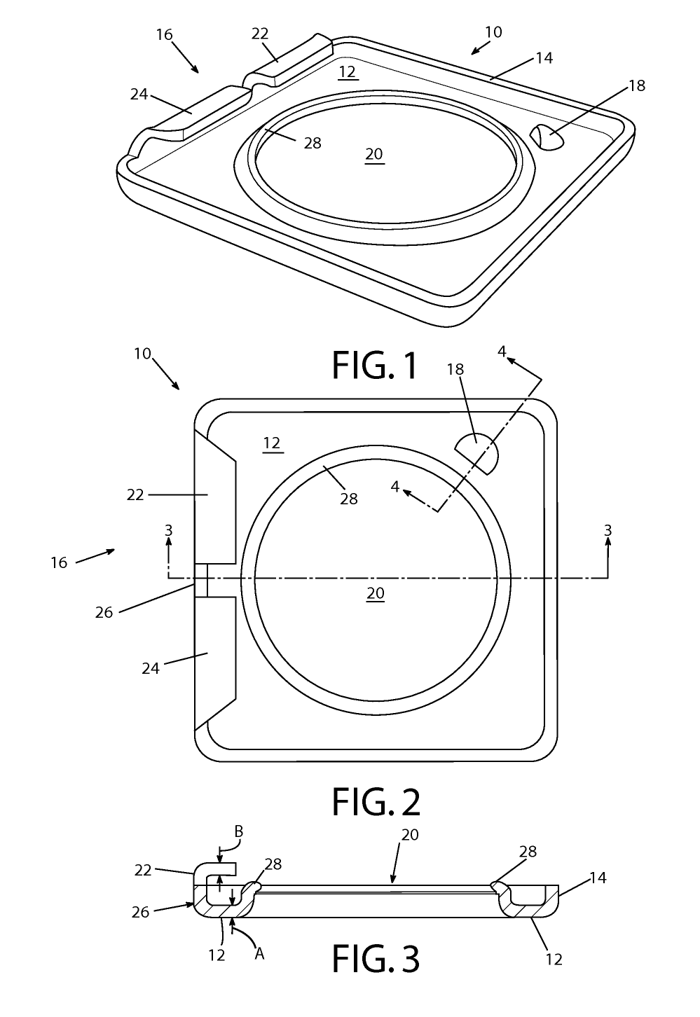

The subject matter disclosed herein relates to an enclosure for an energy storage cell and more particularly to a terminal apparatus for an energy storage cell. Referring to FIGS. 1 through 8, embodiments of a terminal apparatus for an energy storage cell are disclosed. The terminal apparatus and cell housing for an energy storage cell may support a wide variety of electrochemical cells, such as sodium-halide, sodium-sulfur, lithium-sulfur, and other available electrochemical cells used for energy storage. In one embodiment, the electrochemical cells have an operating temperature determined by the melting point of the materials utilized in the cells. For example, the operating temperature may be greater than about 100 degrees Celsius, such as between (and including) 250 degrees Celsius and 400 degrees Celsius, or between (and including) 400 degrees Celsius and 700 degrees Celsius, but other desired operating temperature are also possible.

In an embodiment, a terminal apparatus for an energy storage cell includes a terminal body with a peripheral edge extending around a perimeter of the terminal body such that the terminal body is configured to be secured to a cell housing to retain an electrochemical cell in the cell housing. The terminal body also includes a terminal connector extending from the peripheral edge forming a first terminal for an energy storage cell, a sealable vacuum port extending through the terminal body, and an aperture in the terminal body configured to receive a second terminal of the energy storage cell.

In some embodiments, the energy storage cell (having a terminal apparatus as described herein) can have dimensions of about 37 mm×27 mm×240 mm, any of which dimensions may vary by up to +/−50%, in accordance with various embodiments. In other embodiments, the dimensions of the energy storage cell may vary as desired to support the electrochemical cell for a given application. In embodiments, the chemistry of a cell is of the sodium-metal-halide type, in which NaCl and Ni are converted to Na and NiCl2 during battery charging. The energy capacity of a cell can range from about 30 amp*hours to about 250 amp*hours.

Referring now to FIG. 1, one embodiment of a terminal apparatus 10 for an energy storage cell is illustrated. The terminal apparatus 10 includes a terminal body 12. In an embodiment, the terminal body 12 is monolithic. In an embodiment, a monolithic terminal body consists of one piece of material, such as a single piece of metal that may be modified into the desired configuration of the terminal body. The terminal body may be constructed of electrically conductive material, such as steel or other metals suitable for use with the energy storage cell. In some embodiments, the terminal body may be formed from a single piece of material in a progressive die manufacturing process. The terminal body 12 includes a peripheral edge 14 extending around a perimeter of the terminal body. In some embodiments, the peripheral edge 14 defines four sides, such as four straight sides joined by rounded corners, such that the terminal has a substantially rectangular footprint. In other embodiments, the peripheral edge defines a circular configuration. In various embodiments, the terminal apparatus 10 is configured to be secured to an energy storage cell housing and the peripheral edge 14 is configured to correspond to the geometry of the cell housing. Once secured to the cell housing, the terminal apparatus 10 retains an electrochemical cell in the cell housing.

The terminal apparatus 10 also includes a terminal connector 16 extending from the peripheral edge 14 of the terminal body 12. The terminal connector 16 forms a first terminal for an energy storage cell, and provides an electrical connection point for the energy storage cell. In an embodiment, the terminal connector 16 includes a first tab 22 and a second tab 24 each extending from a first portion 26 of the peripheral edge 14. The terminal 10 also includes an aperture 20 in the terminal body 12 configured to receive a second terminal of the energy storage cell.

The first tab 22 and second tab 24 may be used either individually or in combination as the first terminal of the energy storage cell. A terminal apparatus 10 having a first terminal including two tabs may facilitate manufacturing of the terminal. In one embodiment, a plurality of energy storage cells may be electrically connected in parallel, where the first and second tabs of an energy storage cell are each electrically connected to the first terminal connectors of different energy storage cells. In another embodiment, the first and second tabs of the energy storage cell may be connected to the second terminal of another energy storage cell for those applications in which energy storage cells are electrically connected in series. As illustrated, the first tab 22 and second tab 24 extend from the peripheral edge 14 and are bent inward towards the aperture 20 of the terminal body 12. As shown in FIG. 2, the first tab 22 and second tab 24 extend from the peripheral edge towards the aperture 20 but do not overlap the aperture 20. In other embodiments, the first tab and second tab may extend at least partially over the aperture. The first tab 22 and second tab 24 may be substantially rectangular or may have a polygonal or arcuate configuration as desired. In yet another embodiment, the first tab 22 and second tab 24 may be configured to extend around the aperture 20. In some embodiments, the free ends of the first tab and the second tab may be connected to a portion of the terminal body, such as by welding, to provide added mechanical stability to the terminal connector. In alternative embodiments, the tabs of the terminal connector 16 may extend upward or outward away from the aperture. The terminal connector 16 may be further configured to facilitate the mechanical and/or electrical connection to the energy storage cell.

In an embodiment, the first portion 26 of the peripheral edge 14 corresponds to one of the four sides of the substantially rectangular terminal body 12. In other embodiments, the first portion of the peripheral edge may correspond to less than one side, such as one-half of one side of the peripheral edge. In yet other embodiments, the first portion of the peripheral edge may correspond to that portion of the peripheral edge from which the terminal connector extends. In embodiments where the terminal has a circular configuration, the first portion of the peripheral edge may be a portion, such as one-quarter or one-eighth of the circumference of the terminal defined by the peripheral edge. In various embodiments, the first terminal and second terminal of the energy storage cell may correspond to either the positive or negative terminal of the energy storage cell depending upon the configuration of the cell.

Referring now to FIG. 3, a cross-section of the terminal apparatus 10 is illustrated. In some embodiments, the terminal body 12 includes a lip 28 extending around the perimeter of the aperture 20. The lip 28 may be raised within the aperture 20 as illustrated or may extend downward into the aperture. The terminal apparatus 10 may be configured to retain the electrochemical cell in a cell housing. In an embodiment, an electrically insulating material may be positioned between the electrochemical cell and the underside of the terminal 10. The electrochemical cell may provide the second terminal of the energy storage cell, and the electrically conductive portion of the second terminal may be electrically isolated from the terminal apparatus 10. In yet other embodiments, the lip 28 contacts a portion of the electrochemical cell to assist in retaining the electrochemical cell in the cell housing. The lip 28 may also be welded or otherwise fastened to a portion of the electrochemical cell prior to or during installation of the electrochemical cell in a cell housing.

In some embodiments, the peripheral edge 14 of the terminal body 12 is welded to a cell housing to secure the terminal apparatus to the cell housing. The peripheral edge 14 may provide a weldable edge configured to mate with the cell housing. In some embodiments, the terminal apparatus 10 is secured to the cell housing by a mechanical connection. In one embodiment, the terminal body 12 extends outward from the aperture 20 and is bent approximately 90 degrees to form a weldable edge extending around the perimeter of the terminal. In other embodiments, the peripheral edge may include a portion extending radially from the terminal body or extending downward from the terminal body. In yet other embodiments, the peripheral edge may include a stepped portion configured to seat on a corresponding step in the cell housing.

In embodiments, the terminal apparatus 10 is electrically conductive and conducts current from the electrochemical cell through the terminal connector 16. The electrical resistance of the terminal apparatus thus affects the available power output of the energy storage cell. The electrical resistance of the terminal apparatus 10 may be determined by the conductivity or resistivity of the material selected for the terminal as well as the thickness of the material of the terminal body 12 including terminal connector 16. The thickness of the terminal body 12 adjacent the aperture is indicated by dimension A in FIG. 3. The thickness of the terminal body 12 in the first tab 22 of the terminal connector 16 is indicated by dimension B in FIG. 3. In some embodiments the thickness of the portions of the terminal body will be uniform. In other embodiments, the thickness of the terminal body may vary between different portions. For example, the thickness of the first or second tab may be different than the thickness of the terminal body adjacent the aperture. In an embodiment, the power output of an energy storage cell may be limited by increasing the resistance of the terminal apparatus. In one embodiment, the terminal body has a thickness, such as dimension A and/or dimension B, corresponding to a determined electrical resistance of the terminal body. In an embodiment, the thickness of the terminal connector 14 of the terminal body 12 may be reduced to provide the determined electrical resistance to limit the power output of the energy storage cell.

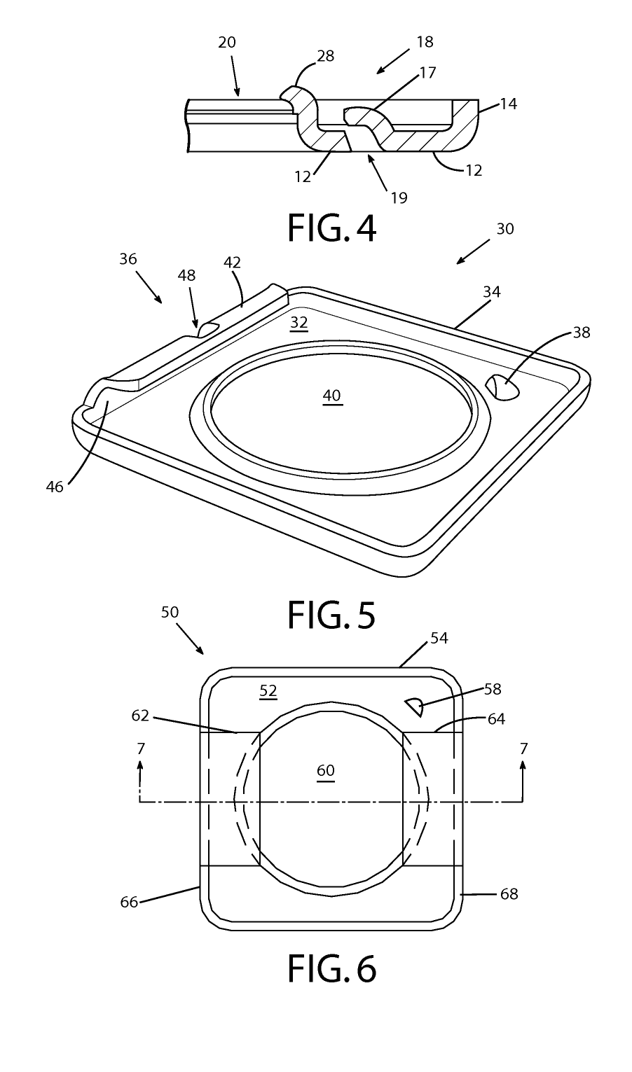

Referring now to FIG. 4, the sealable vacuum port 18 of the terminal apparatus 10 is illustrated in cross-section. In an embodiment, the sealable vacuum port 18 includes a vacuum port aperture, such as opening 19 in the material of the terminal body 12. The opening 19 may be a discontinuity or tear in the terminal body. In one embodiment, the opening 19 is formed by a punch to create a tear in the terminal body leaving an aperture or hole in the terminal body. In other embodiments, the sealable vacuum port 18 may be formed as a pierce or slit, such as a laser cut slit, through the material of the terminal body. In yet other embodiments, the sealable vacuum port 18 may be formed by drilling an orifice through the terminal body 12. In an embodiment, the sealable vacuum port 18 also includes a flap 17. The flap 17 may be a portion of the terminal body 12 displaced when the vacuum port aperture is formed. In some embodiments, the sealable vacuum port 18 is sealable by welding. For example, the flap 17 may be melted, such as by laser welding, to seal the opening 19 in the terminal body. In this manner, the sealable vacuum port may be sealed without adding additional material or a separate component to the terminal body. In other embodiments, the sealable vacuum port 18 may be sealed by securing additional material to the terminal body 12 to cover the opening 19. In yet another embodiment, the flap 17 is integral with a portion of the terminal body 12 that defines the peripheral edge 14 and aperture 20, and the vacuum port aperture, such as opening 19 extends through the terminal body 12, corresponds in shape to the flap such that if the flap is maneuvered into the vacuum port aperture, the flap occupies the vacuum port aperture for sealing the sealable vacuum port. In embodiments, once the terminal apparatus is secured to the cell housing and the vacuum port is sealed, the energy storage cell is hermetically sealed.

Referring now to FIG. 5, another embodiment of a terminal apparatus 30 for an energy storage cell is illustrated. The terminal apparatus 30 includes a terminal body 32 having a peripheral edge 34 defining a substantially rectangular perimeter of the terminal apparatus. The terminal apparatus 30 also includes a sealable vacuum port 38 extending through the terminal body 32. An aperture 40 is provided in the terminal body 32 and configured to receive a second terminal of an energy storage cell. As illustrated, the terminal apparatus 30 also includes a terminal connector 36, which includes a single tab 42 extending from a portion 46 of the peripheral edge 34 (e.g., along the portion 46, which may comprise one entire edge of the body, there is only one tab, namely, the single tab 42). The single tab 42 may function in substantially the same manner as the first tab and second tab previously discussed, for forming a first terminal for an energy storage cell to provide an electrical and mechanical connection to another energy storage cell or application. The single tab 42 may be a solid tab or may include a hole 48 as illustrated in FIG. 5.

Referring now to FIG. 6, another embodiment of a terminal apparatus 50 for an energy storage device is illustrated. The terminal apparatus 50 includes a terminal body 52 having a peripheral edge 54 defining a substantially rectangular perimeter of the terminal apparatus. The terminal apparatus 50 also includes a sealable vacuum port 58 extending through terminal body 52. An aperture 60 is provided in the terminal body 52 and configured to receive a second terminal of an energy storage cell. In an embodiment, the terminal apparatus 50 includes a terminal connector having a first tab 62 extending from a first portion 66 of the peripheral edge 54, and a second tab 64 extending from a second portion 68 of the peripheral edge 54. In an embodiment, the first portion 66 and the second portion 68 each correspond to a different side of the terminal. As illustrated, the first portion 66 is opposite the second portion 68. Embodiments having a first tab 62 opposite a second tab 64 may allow greater flexibility in the assembly and configuration of energy storage cells in an energy storage device, such as a rechargeable battery. In other embodiments, the first tab 62 and the second tab 64 may extend from adjacent sides, such that the second tab 64 is oriented approximately 90 degrees from the first tab. As previously discussed, the first tab 62 and second tab 64 may be used either individually or in combination as the first terminal for the energy storage cell.

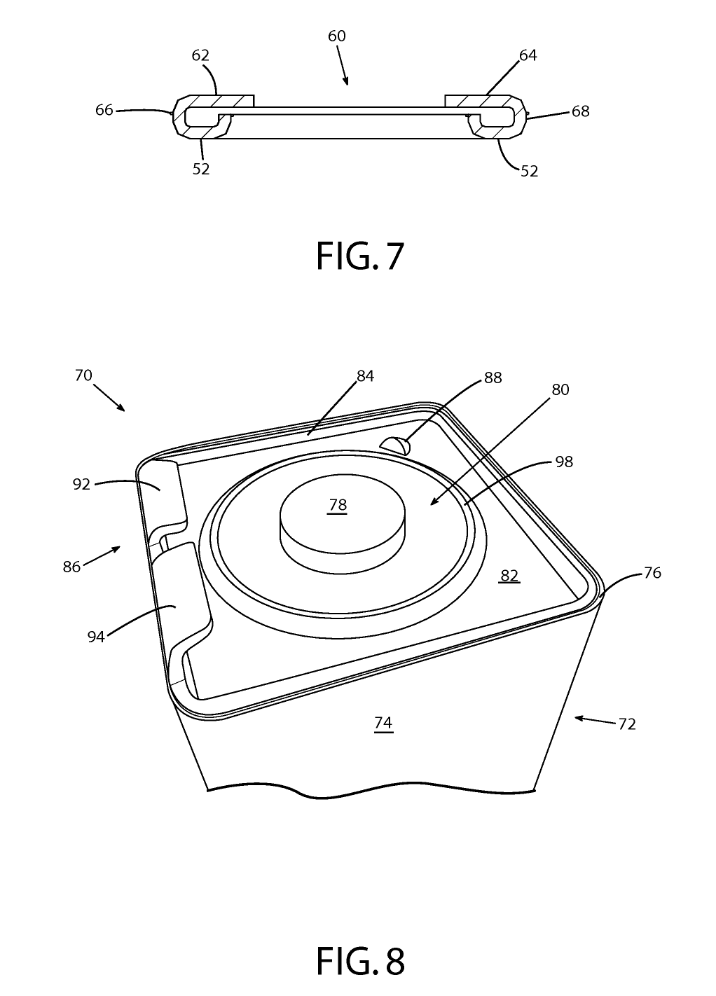

Referring now to FIG. 7, the terminal apparatus 50 is illustrated in cross-section. In an embodiment, the first tab 62 extends from the first portion 66 and the second tab 64 extends from the second portion 68 of the peripheral edge of the terminal apparatus. The first tab 62 and the second tab 64 may also extend over and above at least a portion of the aperture. As previously discussed, the aperture 60 may be provided with a lip, or may be provided without a lip.

Referring now to FIG. 8, also disclosed is an energy storage cell 70 having a terminal apparatus such as those discussed above. In an embodiment, the energy storage cell 70 includes a cell housing 72 having cell walls 74. The energy storage cell includes a rechargeable electrochemical cell 80 disposed within the cell housing 72. The terminal body 82 is secured to the cell housing 72 to retain the electrochemical cell 80 within the cell housing 72. In an embodiment, the electrochemical cell 80 provides a second terminal 78. The second terminal 78 may be accessed through the aperture of the terminal body 82. The terminal apparatus may include a terminal connector 86 having a first tab 92 and a second tab 94. The terminal apparatus also includes peripheral edge 84 configured to correspond to the cell housing rim 76.

In some embodiments, the peripheral edge 84 is welded to the cell housing 72 around the cell housing rim 76. In embodiments, the peripheral edge 84 provides a weldable edge and the terminal apparatus is welded to the cell housing by a weld process suitable to the materials selected for the terminal apparatus and the cell housing. The weld seam between the terminal and the cell housing may be a continuous weld or, alternatively, the weld seam may be two or more discrete welds. In various embodiments, the weld seam is created by a laser weld process, a resistance weld process, an electron beam weld process, a plasma arc weld process, a tungsten inert gas weld process, a wire weld process, a solder weld process, or any other appropriate welding technique. Additionally, the connection between the terminal and the cell housing may be any suitable weld joint geometry, such as butt joint, lap joint, corner joint, edge joint, or T-joint. The peripheral edge of the terminal apparatus may thus be understood as including the portion of the terminal which is secured to the cell housing. In some embodiments, the terminal apparatus may be further secured to cell walls of the cell housing by welding or mechanical connections.

In one embodiment, the second terminal 78 of the electrochemical cell 80 is a positive terminal of the energy storage cell 70. The negative terminal of the electrochemical cell may be conductively coupled to the cell housing 72, which is conductively coupled to the terminal body 82 and the terminal connector 86. In this manner, the terminal connector 86 serves as the negative terminal of the energy storage cell 70. In an embodiment, the second terminal 78 of the electrochemical cell 80 is secured to the terminal body 82 prior to assembly into the cell housing 72. In some embodiments, the electrochemical cell 80 is electrically isolated from the terminal body 82 by an insulator to maintain electrical isolation between the positive terminal and the negative terminal of the energy storage cell 70. In yet other embodiments, the terminal connector 86 is the positive terminal while the second terminal 78 is the negative terminal of the energy storage cell depending on the configuration of the electrochemical cell 80.

In an embodiment, a method of manufacturing an energy storage cell 70 includes securing a terminal body 12 to a cell housing 72 containing an electrochemical cell 80. The method also includes evacuating the energy storage cell 70 through a sealable vacuum port of the terminal body 12, and sealing the vacuum port to maintain a partial pressure within the energy storage cell. As used herein, a partial pressure refers to the reduced pressure achieved by evacuating an enclosure using reasonable commercial methods. In one embodiment, a partial pressure is a vacuum, such as a total vacuum that is free of all atmosphere. In another embodiment, a partial pressure is a nominal residual atmosphere remaining after evacuation of the energy storage cell. As such, a vacuum may be defined as a pressure less than a predetermined threshold, such as no more than 25 millibars, no more than 5 millibars, or no more than 1 millibar. The predetermined threshold may be selected based upon the methods and equipment used to evacuate the energy storage cell.

In yet another embodiment, the method of manufacturing an energy storage cell includes adding an inert gas into the energy storage cell through the vacuum port to achieve the partial pressure within the energy storage cell. In embodiments, the inert gas may be helium or argon. The inert gas may be a noble gas or may be a non-reactive gas formed of two or more elements. In one embodiment, the inert gas is added after the energy storage cell is evacuated. The energy storage cell may be placed in a vacuum chamber and the vacuum chamber evacuated to achieve a vacuum within the energy storage cell. The inert gas may be added to the vacuum chamber, such as through a bleed valve, until the desired partial pressure is achieved within the chamber. With the sealable vacuum port open, the inert gas also enters the energy storage cell. In one embodiment, the inert gas is added such that the partial pressure within the energy storage cell is no greater than 500 millibars. In another embodiment, the inert gas is added until the partial pressure within the energy storage cell is no less than 10 millibars and no more than 300 millibars. In another embodiment, the energy storage cell may be placed in a vacuum chamber. The vacuum chamber may be evacuated while the inert gas is provided to the chamber. The rate of addition of the inert gas and the rate of evacuation of the chamber may be controlled to provide the desired partial pressure within the vacuum chamber and within the energy storage cell. In some embodiments, once the partial pressure is established within the energy storage cell, the sealable vacuum port is sealed such that the energy storage cell maintains the partial pressure within the energy storage cell.

In an embodiment, an energy storage cell having a partial pressure of inert gas is leak tested using an inert gas detector. The energy storage cell may be placed into a vacuum chamber, which is then evacuated. If the energy storage cell is not sealed, inert gas leaking from the energy storage may be detected. In one embodiment, the energy storage cell is provided with a partial pressure of helium and a helium leak tester is utilized to identify leaks from the energy storage cell. In this manner, manufacturing defects may be identified and the energy storage cells repaired prior to incorporation into an energy storage device. This may improve the quality of the energy storage cells and their reliability in various applications, including rechargeable batteries.

In one embodiment, the electrochemical cell 80 is installed into the cell housing 72 and the terminal body 82 is secured to the cell housing without evacuating the energy storage cell. In an embodiment, the method of manufacturing an energy storage cell includes welding the peripheral edge 84 of the terminal body 82 to the cell housing 72 as discussed above. Welding the terminal body 82 to the cell housing 72 may be facilitated by performing this step in a non-vacuum environment where traditional welding techniques may be economically employed. For example, welding in a vacuum environment may require more frequent interruptions in production to clean or maintain the welding equipment. By assembling the electrochemical cell, cell housing, and terminal apparatus in a non-vacuum environment, the amount of welding required to be formed in a vacuum environment is reduced. In addition, the electrochemical cell 80 may be secured to the perimeter 98 of the aperture of the terminal body 82 prior to evacuating the energy storage cell. An insulator may be provided between the electrochemical cell and the terminal body to maintain electrical isolation between the positive and negative terminals of the energy storage device. In some embodiments, a partial pressure of an inert gas is provided within the energy storage cell and an inert gas leak detector is used to ensure a sealed connection between the terminal apparatus, the cell housing, and the electrochemical cell.

In some embodiments, after the terminal apparatus is secured to the cell housing, the energy storage cell may be evacuated by placing one or more energy storage cells in a vacuum chamber or other device capable of being evacuated. During the evacuation process, the atmosphere within the cell housing may be drawn out through the sealable vacuum port 88 until the interior of the cell housing 72 is sufficiently evacuated to provide a partial pressure as previously described. In an embodiment, when the energy storage cell is evacuated and the desired partial pressure established, the sealable vacuum port 88 is sealed by laser welding. Once the sealable vacuum port 88 is sealed, the energy storage cell maintains the partial pressure within the cell housing. The welding occurring under partial pressure, such as under vacuum, is thus limited to sealing the vacuum port. In some embodiments, the welding under partial pressure may have a duration of less than 50 milliseconds per energy storage cell providing a reduction in the total welding occurring under partial pressure and a corresponding increase in the number of energy storage cells that may be produced before maintenance of the welding equipment is required.

Another embodiment relates to a terminal body for a terminal apparatus. The terminal body comprises a terminal body member and a terminal connector. The terminal body member comprises a planar intermediate portion (generally indicated as 12 in FIG. 2), a rim that extends around an outer periphery of the intermediate portion (generally indicated at 14 in FIG. 1), and a lip (generally indicated at 28 in FIG. 1) that defines a central aperture 20 in the terminal body member and thereby extends around an inner periphery of the intermediate portion. The rim defines an outer peripheral edge of the terminal body member. The terminal connector is connected to the rim. In another embodiment, the terminal body member and terminal connector are integral, e.g., formed of the same piece of material. The planar intermediate portion of the terminal body member also defines a sealable vacuum port 18 extending through the terminal body member. In an embodiment, the rim is rectangular, and the lip (and central aperture) is circular.

In embodiments, the intermediate portion defines a major plane (the plane coincident with the surface of 12 in FIG. 1), and the lip and rim are oriented at a non-zero angle with respect to the plane, on the same side of the plane (see FIG. 3). In another embodiment, the terminal connector extends up from the rim and is angled back towards the lip and central aperture (see FIG. 3). The terminal connector may comprise two tabs 22, 24, e.g., each tab attached to the same edge of the rim and extending up from the rim and back towards the lip and central aperture. In another embodiment, the lip extends up from the inner periphery of the planar intermediate portion and then bends radially inward to terminate (e.g., the lip is ∫-shaped) at a radially innermost edge (e.g., annular edge) of the lip, as shown in FIG. 3, for example.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.” The terms “generator” and “alternator” are used interchangeably herein (however, it is recognized that one term or the other may be more appropriate depending on the application). The term “instructions” as used herein with respect to a controller or processor may refer to computer executable instructions.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed is:

1. A terminal apparatus comprising:
a terminal body having:
a peripheral edge extending substantially around a perimeter of the terminal body such that the terminal body is configured to be secured to a cell housing to retain an electrochemical cell in the cell housing;
a terminal connector extending from the peripheral edge forming a first terminal for an energy storage cell;
a sealable vacuum port extending through the terminal body; and
an aperture in the terminal body configured to receive a second terminal of the energy storage cell.

2. The terminal apparatus as claimed in claim 1, wherein the terminal body is monolithic.

3. The terminal apparatus as claimed in claim 1, wherein the peripheral edge of the terminal body has four sides forming a substantially rectangular cross-section.

4. The terminal apparatus as claimed in claim 1, wherein the terminal connector comprises a single tab extending from a first portion of the peripheral edge of the terminal body.

5. The terminal apparatus as claimed in claim 1, wherein the terminal connector comprises two tabs extending from a first portion of the peripheral edge of the terminal body.

6. The terminal apparatus as claimed in claim 1, wherein the terminal connector comprises at least one first tab extending from a first portion of the peripheral edge of the terminal body and at least one second tab extending from a second portion of the peripheral edge of the terminal body.

7. The terminal apparatus as claimed in claim 1, wherein the terminal body has a thickness corresponding to a determined electrical resistance of the terminal body.

8. The terminal apparatus as claimed in claim 1, wherein the peripheral edge is weldable to a cell housing aperture of the cell housing.

9. An energy storage cell comprising a terminal apparatus as claimed in claim 1, wherein the energy storage cell further comprises the electrochemical cell and the cell housing, wherein the electrochemical cell is disposed within the cell housing and the terminal body is secured to the cell housing to retain the electrochemical cell.

10. The terminal apparatus as claimed in claim 1, wherein the vacuum port comprises a flap and a vacuum port aperture, the flap integral with a portion of the terminal body that defines the peripheral edge and aperture, and the vacuum port aperture extends through the terminal body and corresponds in shape to the flap such that if the flap is maneuvered into the vacuum port aperture, the flap occupies the vacuum port aperture for sealing the vacuum port.

11. A method of manufacturing an energy storage cell comprising:
securing a terminal body to a cell housing containing an electrochemical cell;
evacuating the energy storage cell through a vacuum port of the terminal body; and
sealing the vacuum port to maintain a partial pressure within the energy storage cell.

12. The method of manufacturing an energy storage cell as claimed in claim 11, wherein the terminal body comprises a peripheral edge, and securing the terminal body to the cell housing comprises welding the peripheral edge of the terminal body to the cell housing.

13. The method of manufacturing an energy storage cell as claimed in claim 11, wherein the terminal body is secured to the cell housing by a continuous weld.

14. The method of manufacturing an energy storage cell as claimed in claim 11, wherein the terminal body is secured to the cell housing by at least one of a butt joint, an edge joint, a corner joint, a T-joint, or a lap joint.

15. The method of manufacturing an energy storage cell as claimed in claim 11, wherein sealing the vacuum port comprises laser welding.

16. The method of manufacturing an energy storage cell as claimed in claim 11, wherein the terminal body comprises:
a peripheral edge and a terminal connector extending from the peripheral edge forming a first terminal of the energy storage cell; and
an aperture configured to receive a second terminal of the energy storage cell.

17. The method of manufacturing an energy storage cell as claimed in claim 16, wherein the aperture of the terminal body is secured to the electrochemical cell prior to evacuating the energy storage cell through the vacuum port of the terminal body.

18. The method of manufacturing an energy storage cell as claimed in claim 16, wherein the terminal connector comprises a single tab extending from a first portion of the peripheral edge of the terminal body.

19. The method of manufacturing an energy storage cell as claimed in claim 16, wherein the terminal connector comprises at least one first tab extending from a first portion of the peripheral edge of the terminal body and at least one second tab extending from a second portion of the peripheral edge of the terminal body.

20. The method of manufacturing an energy storage cell as claimed in claim 11, wherein the partial pressure is a vacuum.

21. The method of manufacturing an energy storage cell as claimed in claim 11, further comprising:
after evacuating the energy storage cell, adding an inert gas into the energy storage cell through the vacuum port to achieve the partial pressure within the energy storage cell.

22. The method of manufacturing an energy storage cell as claimed in claim 11, wherein the partial pressure within the energy storage cell comprises an inert gas having a pressure no greater than 500 millibars.

23. The method of manufacturing an energy storage cell as claimed in claim 11, wherein the partial pressure within the energy storage cell comprises an inert gas having a pressure no less than 10 millibars and no more than 300 millibars.

24. An energy storage device comprising:
an rechargeable electrochemical cell and a cell housing, wherein the electrochemical cell is disposed within the cell housing; and
a terminal apparatus secured to the cell housing to retain the electrochemical cell, wherein the terminal apparatus comprises a monolithic terminal body having:
a peripheral edge extending substantially around a perimeter of the terminal body wherein the peripheral edge is secured to the cell housing to provide a seal;
a terminal connector extending from the peripheral edge forming a first terminal for the energy storage cell;
a sealable vacuum port extending through the terminal body; and
an aperture in the terminal body configured to receive a second terminal of the energy storage cell; and
wherein the electrochemical cell is secured to the terminal body to provide a seal such that the energy storage device is configured to be evacuated through the sealable vacuum port and configured to maintain a partial pressure when the sealable vacuum port is sealed.

25. The energy storage device as claimed in claim 24, wherein the partial pressure comprises an inert gas having a pressure no less than 10 millibars and no more than 300 millibars.
